(19) United States
(12) Patent Application Publication
(10) Pub. No.: US 2025/0358112 A1
(43) Pub. Date: Nov. 20, 2025

(54) SYSTEMS AND METHODS FOR MULTI-PARTY PRIVATE DATABASE IMPLEMNTATION

(71) Applicant: MongoDB, Inc., New York, NY (US)

(72) Inventors: Archita Agarwal, Secaucus, NJ (US); Zachary Espiritu, Long Island City, NY (US); Marilyn George, Brooklyn, NY (US); Seny Kamara, New York, NY (US); Tarik Moataz, Brooklyn, NY (US); Andrew Park, New York, NY (US)

(73) Assignee: MongoDB, Inc., New York, NY (US)

(21) Appl. No.: 19/209,163

(22) Filed: May 15, 2025

Related U.S. Application Data
(63) Continuation-in-part of application No. 19/208,892, filed on May 15, 2025.
(60) Provisional application No. 63/648,345, filed on May 16, 2024.
(60) Provisional application No. 63/648,372, filed on May 16, 2024.
(60) Provisional application No. 63/648,372, filed on May 16, 2024.

(51) Int. Cl. H04L 9/32

(52) U.S. Cl. CPC H04L 9/32

(57) ABSTRACT

Systems and methods are provided for implementing updatable private set intersection in distributed database architectures (e.g., the well-known MongoDB). The systems and methods can include a new specification language referred to for convenience as “MPPL,” for specifying general multi-party computation protocols. This architecture incorporates private set intersection, accessible via command line operators or other operators formatted according to a native query language. Other embodiments detail systems and methods for integrating multi-party database operations via new server node(s) added to a distributed database system (e.g., MongoDB cluster) that manage communication between parties holding private data.

### RELATED APPLICATIONS

This Application claims the benefit under 35 U.S.C. § 119 (e) of U.S. Provisional Application Ser. No. 63/648,345, filed May 16, 2024, and entitled “SYSTEMS AND METHODS FOR MULTI-PARTY PRIVATE DATABASE IMPLEMENTATION.” This Application claims the benefit under 35 U.S.C. § 119 (e) of U.S. Provisional Application Ser. No. 63/648,372, filed May 16, 2024, and entitled “SYSTEMS AND METHODS FOR IMPLEMENTING PRIVATE SET INTERSECTION IN DATABASES.” This Application claims the benefit under 35 U.S.C. § 120 as a Continuation-in-part of application Ser. No. 19/208,892, filed May 15, 2025, and entitled “SYSTEMS AND METHODS FOR IMPLEMENTING PRIVATE SET INTERSECTION IN DATABASES,” which claims the benefit under 35 U.S.C. § 119 (e) of U.S. Provisional Application Ser. No. 63/648,372, filed May 16, 2024, and entitled “SYSTEMS AND METHODS FOR IMPLEMENTING PRIVATE SET INTERSECTION IN DATABASES.” Each of which applications is hereby incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In many settings, cryptography invokes ideas of encryption and digital signatures. Generally speaking, encryption guarantees the confidentiality of data by making it unintelligible and digital signatures protect the integrity of data by making tampering detectable. Encryption, digital signatures and the technologies they enable, like transport layer security (TLS), full disk encryption, public-key infrastructure (PKI), encrypted messaging and trusted execution environments (TEEs), form the backbone of security not only for the Internet, but for operating systems, file systems, mobile devices and distributed systems.

As important as these cryptographic technologies are, most people fail to realize that they are based on cryptography from the 1990's or even earlier. But in the last 30 years, research in cryptography has advanced considerably and a multitude of completely new cryptographic tools and technologies are available.

### SUMMARY

The inventors have realized that there are significant opportunities to improve new modern cryptography protocols and implement them into conventional spaces, including database management systems. While many modern cryptographic tools are not well-known in industry, this is especially true in the database management space. Various aspects discussed modify newer protocols, optimize them for database tasks, and thus provide novel architectures that are secured and provide secured functionality in a way that conventional implementation cannot provide. The inventors have realized that legacy cryptography is heavily focused on securing communications because it was in large part created to secure the Internet. Such conventional approaches (e.g., legacy crypto technologies) are therefore designed to protect the confidentiality and integrity of data in transit, to authenticate remote users and to protect data at rest.

According to further aspects, optimizing for newer security paradigms, on the other hand, is in large part motivated by the cloud and by awareness of massive data requirements (e.g., “big data”). Various embodiments use concepts of private set intersection-where parties can share private (e.g., encrypted) versions of their data obtaining the benefit of access to both parties' data while the only information revealed is the end result of private queries. Other embodiments answer the questions of “how can one protect their data when it is being stored and managed by someone else?” and “how can a group of people extract value out of their data without having to share it with each other?” by providing modern cryptographic implementation tailored for improving conventional database systems. Further aspects, identify the philosophical difference between the legacy crypto and modern crypto to highlight the advantages of various embodiments discussed herein: legacy crypto focuses mostly on “locking things down” whereas modern cryptography finds ways to lock things down while supporting new applications.

According to one aspect, systems and methods are provided for implementing updatable private set intersection in distributed database architectures (e.g., the well-known MongoDB). The systems and methods can include a new specification language referred to for convenience as “MPPL,” for specifying general multi-party computation protocols. This architecture incorporates private set intersection, accessible via command line operators or other operators formatted according to a native query language. Other embodiments detail systems and methods for integrating multi-party database operations via new server node(s) added to a distributed database system (e.g., MongoDB cluster) that manage communication between parties holding private data.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of an example computer system improved by implementation of the functions, operations, and/or architectures described herein;

FIG. 2 is a block diagram of an example system, according to one embodiment;

FIG. 3 is an example process flow, according to one embodiment;

FIG. 4 is a block diagram of an example system, according to one embodiment;

FIG. 5 is an example code implementation, according to one embodiment;

FIG. 6 illustrates an example protocols and definitions to implement private encryption schemes, according to one embodiment; and

FIGS. 7A-B illustrate an example flow to implement private data techniques, according to one embodiment.

### DETAILED DESCRIPTION

According to various aspects, described are various implementations that integrate multi-party database operations directly into existing query language architectures and described is incorporation of private set intersection as an example of multi-party operation. Also described are systems and methods for implementing updatable private set intersection in distributed database architectures (e.g., the well-known MongoDB). Other embodiments detail systems and methods for integrating multi-party database operations through implementation of a new server node added to a distributed database system (e.g., MongoDB cluster) which includes a new specification language referred to for convenience as “MPPL,” for specifying general multi-party computation protocols. This architecture incorporates private set intersection as an example.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

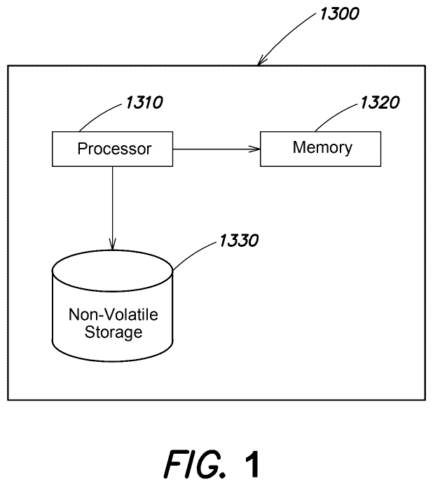

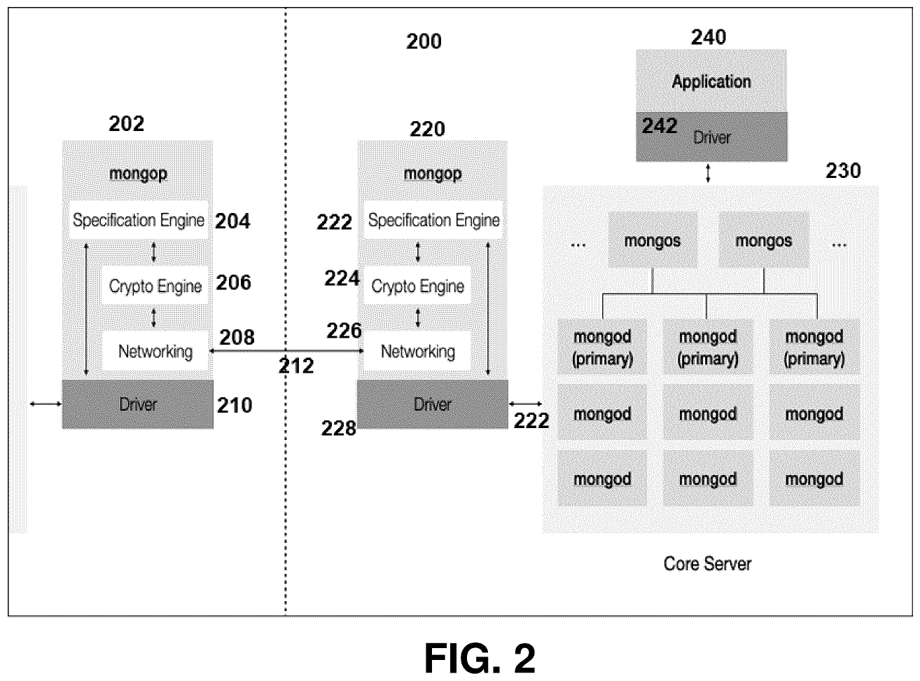

FIG. 1 is a block diagram of an example computer system that is improved by implementing the functions, operations, and/or architectures described herein. Modifications and variations of the discussed embodiments will be apparent to those of ordinary skill in the art and all such modifications and variations are included within the scope of the appended claims. Additionally, an illustrative implementation of a computer system 1300 that may be used in connection with any of the embodiments of the disclosure provided herein (e.g., as shown in FIGS. 2-7B). The computer system 1300 may include one or more processors 1310 and one or more articles of manufacture that comprise non-transitory computer-readable storage media (e.g., memory 1320 and one or more non-volatile storage media 13130). The processor 1310 may control writing data to and reading data from the memory 1320 and the non-volatile storage device 1330 in any suitable manner. To perform any of the functionality described herein (e.g., image reconstruction, anomaly detection, etc.), the one or more processor 1310 may execute one or more processor-executable instructions stored in one or more non-transitory computer-readable storage media (e.g., the memory 1320), which may serve as non-transitory computer-readable storage media storing processor-executable instructions for execution by the one or more processors 1310.

Multi-party computation (MPC) is a cryptographic solution that enables multiple parties to securely compute using a combination of their datasets. “Secure” in this context means that the involved parties do not learn anything about the data of any other party except what they can infer from the output of the computation and their own data itself. MPC is a well-researched field in cryptography that has been studied since the 1980s. General-purpose MPC protocols have been developed to enable parties to securely compute any function over their datasets. However, these protocols are generally inefficient, which has led to a significant amount of work in developing special-purpose MPC protocols for specific tasks.

A special case of MPC is the 2-party setting, where only two parties are involved in the computation, as opposed to multiple parties. This is known as 2-party computation or 2PC in short. The 2-party setting is interesting not only from an applications perspective but also because it allows for the application of special techniques that do not apply in the multi-party case. Therefore, the cryptography community has also dedicated a substantial amount of work specifically to the 2-party setting, developing techniques and protocols tailored for this specific scenario.

### Integrating MPC Into MQL

Most cryptographic technologies used in today's systems are based on methods from the 1990s and were primarily developed to secure Internet traffic. These conventional approaches focus on protecting the confidentiality and integrity of data in transit, authenticating remote users, and safeguarding data at rest. With the rise of cloud computing, data is no longer stored locally but moved to third-party clouds, necessitating new cryptographic technologies to protect this data. Cloud systems typically store data in databases, and applications interface with this data via database operators. Therefore, it is logical to integrate new cryptographic technologies directly into the database. This integration allows application developers to securely work with data without needing to understand the complex cryptographic protocols behind these operators. Mainstreaming the use of cryptography in this way has the potential to significantly impact users worldwide, as applications that use database operators will now have access to secure counterparts.

There are multiple pathways for supporting cryptographic operations on databases. One is to use off-the-shelf cryptographic systems that enable secure data operations. However, integrating such systems into existing applications is challenging because it often requires extensive remodeling of the application. As a result, these cryptographic systems are rarely adopted. The second option is to hire a team of cryptography experts to design a solution and then have engineers build it. However, finding these experts is difficult, and they may not be inclined to work in unrelated fields. Without integrated database operators providing modern cryptographic functionality, it is feasible only for a few large tech companies to build and use these technologies. These companies often develop bespoke solutions tied to their own architectures. By embedding cryptographic functionalities directly into the database, the disclosed systems and methods enable the seamless and easy adoption of secure functionalities. Application developers who already use databases can simply start using the new set of secure operators offered by the database, facilitating a more straightforward transition to enhanced security.

Through MPC integrated into the database, any two database users (e.g., banks, healthcare providers, and governments) can securely compute on the union of their datasets. Each involved party does not learn anything about the other's data except the output of the computation. This capability has several powerful applications with massive impact. In this document, described are embodiments that include designs on how to integrate MPC into existing query languages (e.g., MQL). Different MPC functionalities are supported, and shown by way of example, through various MQL operators, implementing protocols to instantiate these functionalities. Once implemented, multiple users of the improved distributed database (e.g., MongoDB database) can then use these (e.g., MQL) operators to securely compute functions over the union of their datasets. Initially, the description focuses on supporting operators that involve two parties, so described architecture is tailored for this 2-party scenario. Described architectural decisions are additionally based on the 2-party updatable private set intersection (“PSI”) protocol, but various embodiments of the architecture are general and can be adapted for other 2-party secure protocols and various distributed database systems and their respective query language, operators, commands, etc.

### Modeling the Two Parties Involved in 2PC

In the cryptographic literature, 2-party protocols typically designate the two users holding their own data as “parties.” This abstraction hides the complexities of the systems these users employ to store, manage, compute on their data, and communicate with the other user. Assume both parties are MongoDB users, with each party composed of two components: a driver and a server. This is represented by designating the parties as P_0 and P_1, and their respective drivers and servers as D_0, S_0, D_1, and S_1. The driver is where the cryptographic keys are stored, and the server is where the data is stored. In a standard MongoDB setup for a single user i, the user's driver D_i communicates with their server S_i to access the data. However, enabling 2-party protocols in MongoDB requires facilitating communication between parties. To enable intra-party communication, there are various possible architectures, and below embodiments are described with its advantages and disadvantages.

### Adversarial Model

In 2PC, the parties distrust each other and do not want the other party to learn anything beyond the output of the computation. Formally, this “distrust” is modeled as each party assuming the other party is corrupted. Corruptions can be either semi-honest or malicious; however, the following description restricts the model to the semi-honest setting, where parties are assumed to follow the prescribed protocol.

Following this corruption model from the 2PC literature, assume that from one party's perspective, the other party, including its driver and server, is corrupted. However, each party trusts its own components (the driver and the server).

According to various embodiments, private set intersection (PSI) is a 2PC problem where two parties aim to compute the intersection of their respective sets of data without revealing any additional information about the elements that are not in the intersection. A goal in the interaction is to efficiently calculate the intersection while ensuring that neither party learns any information beyond the shared elements in the intersection.

Additional embodiments provide for private set intersection in the context of known database systems, including, for example, MongoDB. For document based database systems, UPSI protocols are translated where the parties are not holding sets of elements but instead a database of documents—providing novel solutions in the case of document databases (referred to as PSI-DD). Each document in the database is a set of field/value pairs. In this context, the problem is translated as follows:
Both Alice and Bob agree on a field f.
The output of the PSI protocol returns all documents in Alice's and Bob's databases that have the same values for field f.
However, Alice should not learn any information about any other documents in Bob's database, and Bob should not learn any information about any other documents in Alice's database.
   Example: As an example, consider the following databases for Alice and Bob. If they decide to compute an intersection over the age field, the documents D11, D13, and D14 from Alice's database and D21 and D22 from Bob's database are returned. This is because both databases contain at least one document with ages 18 and 27. If instead, they decide to compute an intersection over the insurance field, the documents D11, D12, and D22 are returned.

### Alice's Database:

Document D11: {age: 18, insurance: “cigna”}
Document D12: {age: 20, insurance: “cigna”}
Document D13: {age: 18, insurance: “aetna”}
Document D14: {age: 27, insurance: “aetna”}

### Bob's Database:

Document D21: {age: 18, insurance: N/A}
Document D22: {age: 27, insurance: “cigna”}
Document D23: {age: 46, insurance: “guardian”}
   Equivalence between the standard PSI and PSI for document databases (PSI-DD). A PSI-DD problem instance can be converted into a standard PSI instance by treating the values associated with the chosen field in PSI-DD as sets in PSI. The process involves:
1. First, extracting the values associated with the chosen field from both databases as sets.
2. Performing the intersection of these sets using a standard PSI protocol.
3. Returning all documents from either database where the chosen field has a value present in the intersection.
   For instance, in the example above, take the following steps to compute the intersection for the age field:
1. Extract the sets of ages:
   Alice's set of ages: {18, 20, 27}
   Bob's set of ages: {18, 27, 46}
2. Compute the intersection:
   Intersection: {18, 27}
3. Return all documents where the age field has a value in the intersection:
   Documents returned from Alice's set: D11, D13, and D14
   Documents returned from Bob's set: D21 and D22

For example, in MongoDB, step 3 is executed by both drivers making a find query to retrieve the documents that match the intersection values. This equivalence allows a study of the standard PSI problem independently, develop efficient solutions, and then apply these solutions to the PSI-DD problem. Similar approaches have been implemented in the context of other dynamic schema and/or document based database systems.

Example Variants of PSI-DD. In the PSI-DD variant discussed above, Alice receives both her documents and Bob's documents, which contain values from the intersection. Alternatively, depending on the use case, we can implement another variant of PSI-DD where Alice receives only her documents that contain a value in the intersection. In contrast, Bob receives only his corresponding documents. For example, in the scenario described, Alice would receive documents D11, D13, and D14, while Bob would receive only D21 and D22. These two variants offer slightly different functionalities, and the choice between them depends on the specific requirements of the use case. The following description starts with the first variant

### Example PSI-DD in MongoDB

To enable MongoDB customers to perform PSI-DD, three steps can be involved:
1. Linking the parties to enable communication between them
2. Granting permissions to each other
3. Performing the PSI-DD computation

Example Outline of steps: agnostic of the specific intra-party communication architecture chosen. The description provides a high-level overview of the steps for each party. Once the intra-party communication architecture is chosen, the description elaborates on the components of each party that are responsible for executing these steps.

### Linking the Two Parties

According to one embodiment, the first step involves establishing a secure connection between the two parties who wish to perform PSI-DD or any other form of 2PC or MPC. This process, known as linking, involves creating a secure communication channel between the parties.

For instance, if Alice and Bob, two MongoDB users, want to perform PSI-DD on their databases, they must first create a link using urlStringA and urlStringB as their respective identifiers: link=network.link (urlStringA, urlStringB); Once Alice and Bob agree and the linking process is successful, both parties receive a link that allows them to securely send messages to each other.

### Granting Permissions

For example, the link created in Step 1 allows the parties to communicate. Next step: grant each other permissions to perform computations on specific collections and fields. This is done by creating permissioned links that define the collections, fields, and types of operations that can be performed. For example, if Alice and Bob wish to perform PSI-DD on their respective collections, collectionA and collectionB, and fields fieldA and fieldB, they would grant each other permissions as follows: permissionedLink=link.grantPermissions (collectionA, collectionB, fieldA, fieldB, “psi”).

In some examples, the system is configured for creating permissioned links for specific collections and fields enhances security by ensuring that a party granted access to one field cannot inadvertently or maliciously access or compute PSI-DD with fields that the other party did not authorize. This granular control over field-specific access helps maintain data privacy, preventing unauthorized intersections and limiting potential exposure of sensitive information.

For example, if Alice grants Bob access to perform PSI-DD on the age field in collectionA, but not on the insurance field, Bob cannot exploit the link to gain access to the insurance field of Alice. This isolation ensures that each field's data is protected and only shared as explicitly agreed upon, reinforcing security in collaborative data operations.

### The PSI-DD MQL Operator

According to one embodiment, once the parties establish a permissioned link, they can use MongoDB's query language (MQL) to perform secure computations. For PSI-DD, a new operator called privateMatch is introduced in MQL. For example, when Alice wants to securely compute the intersection of collectionA.fieldA with Bob's collectionB.fieldB, she executes the following command: intersection=permissionLink.privateMatch( )

Behind the scenes, the privateMatch operator implements a PSI-DD protocol, which, in turn, relies on a PSI protocol. Specifically, the pseudocode for the privateMatch operation is as follows (assuming, without loss of generality, that Alice executes the operation):

```
function privateMatch(collectionA, fieldA, collectionB, fieldB) {
  // Step 1: Alice initiates the PSI-DD process by sending a request to Bob
  permissionedLink.psiInitiate( );
  // Step 2: Alice Bob independently extract values associated with the chosen fields as
sets.
  let aliceSet = db.collectionA.distinct(“fieldA”); // Alice extracts her field values
  let bobSet = db.collectionB.distinct(“fieldB”); // Bob extracts his field values
  // Step 3: Alice Bob perform the intersection of their sets using a standard PSI protocol.
  The intersection is computed interactively through the PSI protocol.
  let intersection = psiProtocol(aliceSet, bobSet);
  // Step 4: Alice and Bob query their respective databases to retrieve documents
  containing the intersection values.
    let resultAlice = db.collectionA.find({ “fieldA”: { $in: intersection } }); // Alice
  retrieves her matching documents
    let resultBob = db.collectionB.find({ “fieldB”: { $in: intersection } }); // Bob retrieves
  his matching documents
  // Step 5: Alice and Bob exchange their result sets.
  // Step 6: Alice and Bob combine their results to obtain the final union of matching
  documents.
      Alice outputs resultAlice.concat(resultBob);
      Bob outputs resultBob.concat(resultAlice);
}
```

In some embodiments, the PSI protocols from Step 3 would typically involve multiple rounds of communication, making them interactive. Therefore, the protocol can be configured to manage both parties so that they remain online throughout the PSI-DD computation process, or to terminate and resume upon connection. In some examples, state information can be used to resume operations that require interaction.

### Updatable Private Set Intersection (UPSI)

For many PSI applications, including online advertising and password breach monitoring, set intersections are computed multiple times as the sets grow or shrink over time. This concept of updatable PSI (UPSI) is particularly useful in database settings where two parties, such as database users, wish to compute intersections multiple times as they add or remove data from their databases.

Using PSI protocols for UPSI. Given a PSI protocol, performing updatable PSI includes: run the PSI protocol whenever an intersection is needed. For instance, suppose Alice and Bob have initial sets A and B. They first run the PSI protocol to compute the intersection I. If Alice updates her set to A′ and Bob updates his to B′, they can simply run the PSI protocol again to compute the new intersection I′.

Example Advantages of designing UPSI protocols. Instead of repeatedly using a PSI protocol, embodiments use a UPSI protocol specifically designed for efficiently computing multiple intersections. Here, “efficient” covers having communication and computation complexities that are sublinear relative to the size of the current sets (instead of linear). By leveraging UPSI protocols, updates to the intersection results are processed more efficiently, saving on both computational and communication overheads. UPSI protocols thus provide a more efficient solution for scenarios where set intersections need to be computed multiple times, making them highly suitable for dynamic database environments.

### A Framework for Updatable PSI From StE for Sets

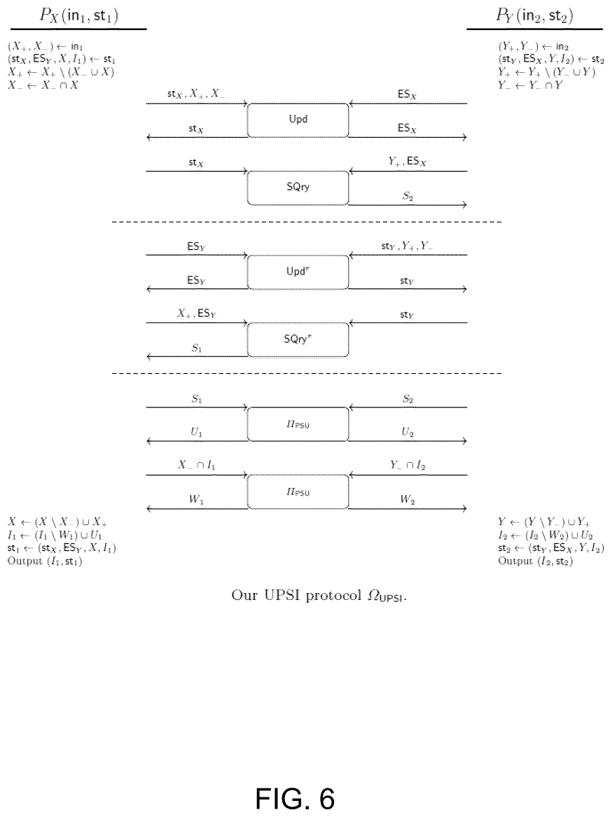

Embodiments use the UPSI framework discussed herein to construct an updatable PSI (UPSI) protocol. The framework uses a dynamic Structured Encryption (StE) scheme with server-side querying and any Private Set Union (PSU) protocol. Provided is an overview of the framework for clarity and completeness. The general UPSI framework is illustrated in FIG. 6.

### Example Framework Overview

The framework uses a dynamic Structured Encryption (StE) scheme to create, update, and query the encrypted sets on the server side. Parties are P_{X} and P_{Y} with input sets X and Y. Let X₊ and X₋ be the elements that P_{X} wants to add and delete from set X, and similarly, Y₊ and Y₋ for P_{Y}. Given the existing intersection I=X∩Y, for one epoch of updates, notice that the updated intersection:

$$I ’ = ( I ∖ W ) ⋃ U ,$$

$$where ,$$

$$W = ( {X}_{-} ∩ I ) ⋃ ( {Y}_{-} ∩ I ) , and U = ( {Y}_{+} ∩ X ’ ) ⋃ ( {X}_{+} ∩ ’ Y ) ,$$

and X′ and Y′ are the updated sets X and Y. The framework allows the parties to compute the sets U and W, and given these sets, the parties can then compute the updated intersection locally. In the framework, each party holds an encrypted data structure that represents the other party's current set, and proceeds as follows:
Set U (elements to be added to the current intersection): P_{X} first updates the encrypted set X to X′ (held by P_{Y}). After the updates, P_{Y} runs the server-side membership query protocol on the encrypted set X′ to compute (Y+N X′). By the symmetric process, P_{X} computes (X₊∩Y′). The parties then use a PSU protocol to compute the set U.
Set W (elements to be removed from the current intersection): P_{X} computes (X₋∩I) locally, and similarly, P_{Y} computes (Y₋∩I). They then use a PSU protocol to compute the set W.

In more detail, the framework incorporates each party's additions X₊, and Y₊ and deletions X₋ and Y₋, and computes the updated intersection as follows, assuming that each party holds an encrypted set representing the other party's previous set and knows the intersection of these previous sets, denoted as I₁ and I₂, where I₁=I₂. In the first epoch of the protocol, these encrypted sets and the intersection can be considered empty.
1. Input Validation: Both parties ensure their updates, X₊, X₋, and Y₊, Y₋, are well-formed (e.g., only deleting elements that are present in their sets, and only adding elements that are not currently present in their sets).
2. First Interactive Stage:
   P_{X} acts as the client and runs the update protocol from the StE scheme to perform the updates X₊ and X₋ on its encrypted set ESX, which is held by P_{Y}.
   P_{Y} then uses the server-side query of the StE to query the updated ESX with its additions Y₊. The output to P_{Y} is the set S₂=(Y₊∩X′).
3. Second Interactive Stage: This stage is symmetric, with the roles of the parties reversed. At the end of this stage, party P_{X} gets the set S₁=(X₊∩Y′).
4. Union Computation:
   The parties run a PSU protocol on sets S₁ and S₂ to learn their union U=S₁∪S₂. In the figure, U is denoted as U=U₁=U₂. The parties must add U to the current intersection.
   The parties run a PSU protocol again with the inputs (X₋∩I₁) and (Y₋∩I₂) to compute the set W. In the figure, W is denoted as W=W₁=W₂. The parties must remove W from the current intersection
5. Intersection Update: Both parties locally update the previous intersection to compute the new intersection.

### OSX: A Set StE Scheme With Server-Side Querying

The UPSI framework herein uses a set encryption scheme with server-side querying as one of its key components. To instantiate this within the framework, embodiments use OSX, a set encryption scheme with server-side querying described herein.
Example Structured Encryption (StE) schemes. StE schemes are encryption techniques that allow data structures to be encrypted in such a way that they can be privately queried. In a standard setting, StE schemes allow:
1. Setup: At setup time, the client, the owner of the data structure, encrypts the structure and uploads it to an untrusted server.
2. Updates and Queries: The client can later update (by adding or deleting elements) and query the encrypted data structure.
   In traditional StE schemes, the client issues both updates and queries. These schemes have been extensively studied since the early 2000s, focusing on ensuring that the server does not learn anything about the data or the queries (beyond minimal leakage).
   StE Schemes with Server-Side Querying. In contrast, StE schemes with server-side querying allow the untrusted server to issue queries on the client's encrypted data structure, rather than requiring the client to perform those queries. Shown herein is how to convert client-side query protocol of standard StE schemes into a server-side query protocol. This conversion effectively enables modification of standard StE scheme to support server-side querying, broadening its applicability to scenarios where the server must query on encrypted data (as required in the UPSI framework).
   StE Schemes for Sets. A set encryption scheme is a StE scheme tailored for sets of elements. The scheme allows:
1. Set Encryption and Updates: The client can encrypt a set of elements and subsequently update it by adding or deleting elements.
2. Membership Queries: The scheme supports membership queries, allowing the client to check whether specific elements are present in the current set.
   In cases where the scheme supports server-side querying, these membership queries are issued by the server rather than the client.

### Overview of OSX

The UPSI framework described uses a set encryption scheme with server-side querying as one of its components. To instantiate this within the framework, use OSX, a set encryption scheme with server-side querying discussed herein. OSX itself includes building blocks:
1. Oblivious Key-Value Store (OKVS)
2. F_{VODPC} Ideal Functionality
   Discussed is a brief overview of the OSX scheme and reference to detailed explanation above (e.g., FIG. 6).

Example Batch Update process. At a high level, OSX uses multiple OKVS structures to represent an encrypted set. Each update is represented by a new OKVS, where the labels correspond to the elements being added or deleted, and their values are ciphertexts representing the constant “1.” In particular, the batch update process works as follows. The client encodes the elements in X₊ and X₋ as labels in an OKVS, with the corresponding values being ciphertexts of the constant “1.” Once the OKVS is constructed with the updated elements, the client sends this new OKVS to the server. The server stores this new OKVS alongside all previous OKVS structures it has received from the client. The set of all the OKVSs together represents the encrypted set.

Example Server-side (batch) query process. To query an element x, the server queries every OKVS for the label x and counts the number of ciphertexts that decrypt to “1.” If the count is even, x is not currently in the set; if the count is odd, x is in the set. However, the client holds the key to decrypt the ciphertexts and we want to support server-side querying with minimal leakage. Therefore, the server-side query protocol operates as follows:
1. For each element in the query set X_{qry}, the server queries all existing OKVSs to retrieve the corresponding ciphertexts.
2. The client and server then jointly invoke the F_{VODPC} protocol, which securely decrypts the ciphertexts, counts the number of “1” values and outputs the parity of the final count to the server.
   The query leakage to the client is limited to the number of queries the server made, while the server learns nothing about the client's set due to the encryption scheme's security, the obliviousness of the OKVS, and the privacy guarantees provided by F_{VODPC}.

### UPSI for Document Databases (UPSI-DD)

Below is described an example instantiation of the PSI-DD problem, for example, in MongoDB. A similar approach is used in other embodiments for other document based databases and/or other dynamic schema databases.

Updatable Private Set Intersection for Document Databases (UPSI-DD) extends the concept of PSI-DD to allow MongoDB customers to securely compute intersections over their databases multiple times, even as the databases are updated. This capability is useful for applications where the data is frequently changing, and the intersections need to be recalculated regularly. The workflow for UPSI-DD is similar to the one for PSI-DD, with the added flexibility of handling updates between intersections. The steps involved are:
1. Linking the Parties: The parties establish a secure link, allowing them to communicate with each other.
2. Granting Permissions for Computation: The parties grant each other permissions to perform computations on specific collections and fields
3. Making Updates to the Database: The parties can repeatedly update their databases as needed, with the updates being communicated to the other party to keep their encrypted sets synchronized.
4. Performing the UPSI-DD Computation: The parties can also repeatedly compute the intersection of the specified fields.

### Making Updates to a UPSI-Enabled Database

In this section, detailed is how the existing database update operations are modified to seamlessly integrate with intersection operations on a UPSI-enabled database. Recall for a UPSI framework, when a party updates its database, these updates are also communicated to the other party. For instance, when using OSX to instantiate StE in the UPSI framework, the party would create an OKVS that encodes the elements being added or deleted and send this OKVS to the other party. As an example, consider Alice's database, which initially contains the following documents:

### Alice's Database:

Document D11: {age: 18, insurance: “cigna”}
Document D12: {age: 20, insurance: “cigna”}
Document D13: {age: 18, insurance: “aetna”}
Document D14: {age: 27, insurance: “aetna”}
   Suppose Alice decides to update the age field in Document D12 from 20 to 55. This change is equivalent to removing the value 20 and adding the value 55 to her set of ages, changing it from {18, 20, 27} to {18, 55, 27}. To maintain the correctness of the intersection protocol, Alice updates her encrypted set of ages that Bob holds. She does this by creating an OKVS that includes labels for both 20 (to be removed) and 55 (to be added), with their values being ciphertexts of “1.” This OKVS is then sent to Bob, who updates the encrypted set accordingly.

### Example Execution: Batching Updates

In the example, Alice can communicate with Bob every time she makes an update to her database. This approach would require Bob to be continuously online to receive Alice's updates, which is both inefficient and impractical in real-world settings. To address this issue, embodiments batch updates between intersections. Instead of sending updates immediately, parties accumulate their changes and send them in a single batch right before the next intersection computation. This approach eliminates the need for the other party to always be online to receive updates, enhancing efficiency and practicality. Additionally, since both parties are required to be online for the intersection computation anyway, the batching of updates aligns well with the existing workflow.

Embodiments can implement a number of approaches for batching updates. Two example approaches are described for batching updates. Described are two methods for accumulating updates in a UPSI-DD system:
1. Incremental Metadata Tracking: In this approach, each party maintains metadata that is updated with every change made to their respective databases. This metadata essentially keeps a log of all updates performed. For instance, when Alice updates her database, the update operation simultaneously modifies her metadata to reflect these changes.
2. Intersection-Time Metadata Tracking: In the second approach, the parties maintain metadata that only tracks the elements in the set at the time of the intersection. This metadata is updated when the parties are preparing to perform an intersection, rather than with every database update.
   The second approach has several advantages over the first (while either/both can be used):
Reduced Overhead: The first approach imposes additional overhead on every database update operation, as each operation must also update the corresponding metadata. This continuous updating process can be resource-intensive and may slow down normal database operations.
Avoidance of Write Conflicts: In the first approach, since all update operations attempt to modify the same metadata, the metadata can become a bottleneck, leading to significant write conflicts and reduced throughput.
Simplicity: The second approach is inherently simpler. By deferring metadata updates until the intersection is needed, it avoids the complexities and potential performance issues associated with continuously tracking every change.

### Example Implementation: Incrementally Tracking Updates

### Metadata Collection and Document

For each UPSI-DD field, a special meta collection named _upsi_metadata is created in the user's database. This collection contains a single document that holds two array fields: current_set and updates_made.
current_set: This field stores the elements currently present in the user's set.
updates_made: This field tracks the elements that have been added or removed since the last intersection. After each intersection is computed, the updates_made field is cleared out and reset, ensuring it only contains changes made after the most recent intersection.
   Henceforth, references to the document in the _upsi_metadata collection as the metadata document.
   As an example, the metadata document for Alice's database looks like the following:

```
{
  “current_set”: [18, 20, 27],
  “updates_made”: [20, 55]
}
```

In this example, Alice's current_set includes the values 18, 20, and 27, while the updates_made field reflects recent changes, indicating that 20 has been removed and 55 added. After the intersection is computed, the updates_made field will be cleared and ready to track future changes.

### How and When the Metadata Document Gets Updated

Updating current_set. The current_set field is updated whenever a user makes changes to their database. This includes inserting a new document, deleting an existing one, or updating an existing document. After any such modification to the database, evaluate whether the change affects the metadata documents. Specifically, if an element needs to be added to or removed from the set underlying the user's database, adjust the current_set field accordingly. Note that not every document insertion or deletion leads to changes in the current_set. For example, if a new document is added with a value that already exists in the current set, no changes are needed. Similarly, if a document is deleted but the value it contained still exists in other documents within the database, that value remains in the current_set.

Updating updates_made. Whenever an element is added to or removed from the current_set, check whether this element is already in the updates_made set. If it is present, it is removed from updates_made; if it is not present, it is added. This process ensures that if an element is both added and deleted within the same epoch (i.e., between two intersections), these changes effectively cancel each other out and do not need to be communicated to the other party. Let A represent the set of elements added, and D the set of elements removed, during the current update operation for the UPSI-DD field field_name.

function updateMetadataDocuments (field_name, A, D):

```
    let U be an empty set
    let metadataDoc = db._upsi_metadata.findOne( );
    // Step 1: Update the current_set document
    for each element x in A:
      if x not in metadataDoc.current_set:
        add x to metadataDoc.current_set
              add x to set U
    for each element x in D:
      // Check if x still exists in the database before removing
      if not db.collection.findOne({ field_name: x }):
        remove x from metadataDoc.current_set
              add x to set U
    // Step 2: Update the updates_made document
    for each element x in U:
          if x in metadataDoc.updates_made:
            remove x from metadataDoc.updates_made
          else:
            add x to metadataDoc.updates_made
Alice's Example. Revisit the example of Alice from above:
Alice's Database:
        Document D11: { age: 18, insurance: “cigna”}
        Document D12: { age: 20, insurance: “cigna”}
        Document D13: { age: 18, insurance: “aetna”}
        Document D14: { age: 27, insurance: “aetna”}
Initially, her metadata document looks like this:
{
        current_set: [18, 20, 27],
        updates_made: [ ]
}
```

Suppose Alice updates Document D13 by changing the age from 18 to 55. This update affects the metadata as follows:
1. Since Alice changed the age from 18 to 55, the value 18 potentially needs to be removed from the current_set, and 55 possibly needs to be added.
2. Since the database contains another document (D11) with age 18, the value 18 is not removed from the current_set.
3. Since 55 is not already in current_set, it is added to current_set.
4. Since 55 is not already in updates_made, it is also added to updates_made.
   After these changes, Alice's collection looks like the following:

### Alice's Database:

Document D11: {age: 18, insurance: “cigna”}
Document D12: {age: 20, insurance: “cigna”}
Document D13: {age: 55, insurance: “aetna”}
Document D14: {age: 27, insurance: “aetna”}
   Alice's metadata document:

```
{
  “current_set”: [18, 20, 27, 55],
  “updates_made”: [55]
}
```

Now suppose Alice deletes Document D13. The metadata updates as follows:
Since no other document contains the age 55, 55 is removed from current_set.
Since 55 was already in updates_made, it is also removed from updates_made.
   After this deletion, her metadata document looks like this:

```
{
  “current_set”: [18, 20, 27],
  “updates_made”: [ ]
}
```

This process highlights how the metadata document dynamically reflects the current state of the database while efficiently managing updates and deletions.

### Modifying Existing Operators for UPSI-DD

As noted above, to ensure the correctness of the metadata documents in a UPSI-enabled database, modifications to the database need to trigger corresponding updates to the metadata. Therefore, proposed for some embodiments is a wrapper around existing MongoDB update operators, referred to as the upsi_xxx counterparts. These wrappers ensure that the metadata updates occur automatically whenever a user modifies the database. Similar wrappers can be used in the context of other document based database systems as well as other dynamic schema database systems.

In a UPSI-enabled database, users replace their use of original database operators with these upsi_xxx counterparts. By doing so, the complexities of managing the underlying metadata are handled seamlessly in the background. These wrappers follow a standardized stencil for update operators, which is illustrated using the modify( ) operator as an example: function upsi_modify(arg):
1. Perform the Original Operation: The upsi_modify( ) wrapper first executes the original modify(arg) operation to apply the intended changes to the database.
2. Compute Added Elements (Set A): After the modification, the wrapper identifies the set of elements being added to the database due to this operation. This set is denoted as A.
3. Compute Deleted Elements (Set D): Similarly, the function determines the set of elements being removed from the database, referred to as D.
4. Update Metadata Documents: Finally, the upsi_modify( ) function updates the metadata documents by executing the updateMetadataDocuments(field_name, A, D) function, where field_name is the name of the UPSI-DD field.

### Example Implementation: Intersection-Time Metadata Tracking

The described approach can involve incrementally tracking updates. A more efficient alternative to incremental metadata tracking is intersection-time metadata tracking. In this approach, the parties compute the updates made since the last intersection only at the time of the next intersection. Rather than risking continuously updating metadata with each database change, the parties project the values in the UPSI-DD field as a set right before they intend to perform an intersection. They then compare this current set with the set from the last intersection. Specifically, they calculate the set of elements added by performing a set difference (current set\last set) and the set of elements deleted by performing (last set\current set). For metadata, each party maintains a minimal record by storing only the old set from the last intersection. This is done by creating a metadata collection, _upsi_last_set, containing a single document with an array field called elements, which stores the elements of the set at the time of the previous intersection. When a new intersection is computed, the elements field is simply updated with the elements of the currently projected set. An example benefit of some embodiments include that it eliminates the overhead on database updates, consolidating the work into the intersection operation itself. This reduces contention and improves overall system performance.

### The repeatedPrivateMatch Operator in MQL

Above embodiments describe how existing database update operations can be modified to work seamlessly with intersection operations on a UPSI-enabled database-for example, with MongoDB. Other examples can be extended as discussed to other document based database and/or dynamic schema database implementations. To provide additional implementation examples, a new operator for the MongoDB Query Language (MQL) is described which would enable the parties to repeatedly compute intersections.

For UPSI-DD, the repeatedPrivateMatch operator is introduced into MQL to facilitate secure and efficient computation of intersections across two datasets. This operator handles the complexities of repeated intersections by implementing cryptographic UPSI protocols in the background.

As an example, consider a case where Alice wants to repeatedly compute intersections of collectionA.fieldA with Bob's collectionB.fieldB. She would execute the following command, wherepermissionLink is the secure link she previously established with Bob on collectionA.fieldA and collectionB.fieldB: intersection=permissionLink.repeatedPrivateMatch( ).

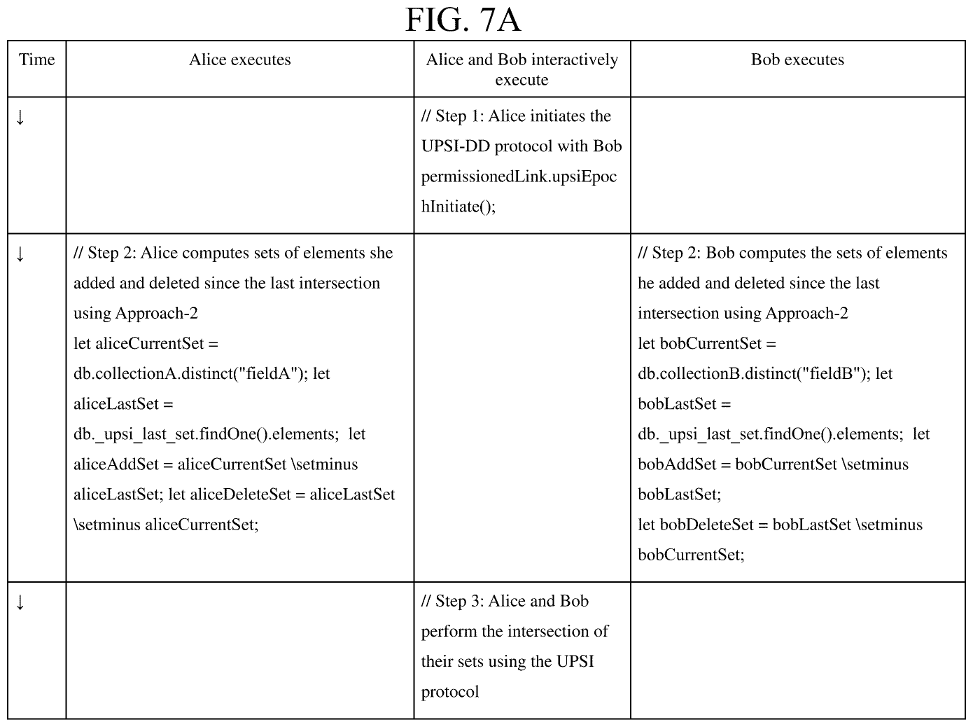

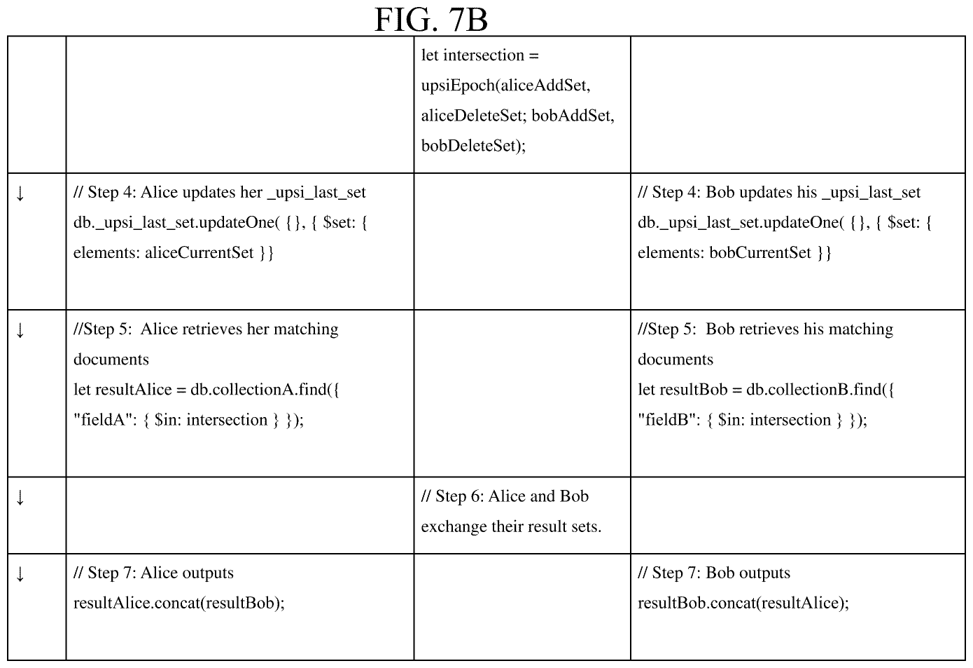

Behind the scenes, the repeatedPrivateMatch operator implements an epoch of UPSI-DD protocol. Specifically, the pseudocode for the repeatedPrivateMatch operation is as shown in FIG. 7A-B. The example assumes, without loss of generality, that Alice executes the operation and that we are using Intersection-Time Metadata Tracking to track updates.

### Example Emulation

The repeatedPrivateMatch( ) operator implements an (epoch of the) UPSI protocol (OSX-instantiated UPSI framework) by using emulation, a technique that helps adapt cryptographic UPSI protocols into MongoDB queries and updates. This allows intersection operations to be executed using a database's (e.g., MongoDB's) native capabilities while preserving the security guarantees of the UPSI protocol. Specifically, encrypted data structures, such as an encrypted multi-map, and the algorithms used to query them are respectively translated into, for example, MongoDB-friendly document databases and MQL operators. This example approach ensures that the intersection operations defined by the UPSI protocol are seamlessly integrated into MongoDB's infrastructure.

In this section, an outline of the process of emulating the UPSI protocol is provided. Rather than describing the entire emulation in one step, the description breaks it down into multiple stages. Begin with emulating the basic building blocks and then gradually build the emulated protocol on top of them. Recall that the UPSI framework uses the following components: OSX, a PSU protocol, and generic 2PC, with OSX itself utilizing an OKVS. In the first stage, discussed is how to emulate an OKVS, then proceed to the emulation of OSX, and finally, detailed is the emulation of the entire framework.

Storage-level emulation. Note that example does not describe a full emulation but a storage-level emulation. The difference between full and storage-level emulation is that the latter only emulates the data structures of the cryptographic protocol but not its query and update algorithms. In other words, the emulated version requires no modifications to MongoDB's server storage system but uses the new query and update algorithms. Note that it is possible to fully emulate the UPSI protocol, but storage-level emulation results in a more efficient scheme.

### Emulating Oblivious Key-Value Stores OKVS

### RB-OKVS: An OKVS Based on Random Band Matrices

In OSX, instantiated is an Oblivious Key-Value Store (OKVS), using RB-OKVS—an OKVS based on random band matrices. Here's how RB-OKVS functions:

Initialization: The syntax is R₁, R₂←Init(k, λ, n, m, w). During initialization, the algorithm takes in two security parameters: k, the computational security parameter, and λ, the statistical security parameter. Additionally, it receives n, the number of labels to be encoded in the OKVS; the encoding size given by m=(1+ϵ)n; and a width parameter w, where w≤m. The algorithm outputs two hash keys R₁ and R₂, each λ-bits long. The first hash function, H₁, maps each label to an integer within the range {1, . . . , m−w}, such that H₁(R₁,l)∈{1, . . . , m−w}. The second hash function, H₂, maps each label to a w-bit string, such that H₂(R₂,l)∈{0,1}^{w}.
Encoding: The encoding algorithm s=Encode({(lᵢ,vᵢ)}_{i∈[n]}, R₁, R₂) takes as input a set of n label-value pairs, denoted as {(l₁,v₁), . . . , (lₙ, vₙ)}, along with the hash keys R₁ and R₂. It takes as input a set of n label-value pairs, denoted as {l₁, v₁), . . . , (lₙ, vₙ)}, along with the hash keys R₁ and R₂. It outputs a vector s of size m×1, computed as follows. First, an n×m matrix M is created, where each row i corresponds to a label lᵢ. For each i∈[n], H₁(R₁,lᵢ) determines the starting position of a w-bit random band, and H₂(R₂,lᵢ) generates the contents of this band. The random band H₂ (R₂,lᵢ) is then embedded in the row starting at the position determined by H₁(R₁, lᵢ), with the remaining positions in the row set to 0. The algorithm then solves for the vector s such that M·s=[v₁, . . . , vₙ]^{T}.
Decoding: In the decoding phase, the decoding algorithm v=Decode(s, l, R₁, R₂) takes as input the encoded vector s, a query label l, and the hash keys R₁ and R₂. It uses the same random functions H₁ and H₂ with the keys R₁ and R₂ to reconstruct the starting location H₁(R₁,l) of the w-bit random band, and the contents of the band H₂(R₂,l). The algorithm then computes the dot product between the w-bit vector H₂(R₂,l) and the corresponding w-bit subsequence of s starting at the position H₁(R₁,l). The result v of this dot product is returned as the output.
At a high level, an Oblivious Key-Value Store (OKVS) is considered correct if the Decode function accurately retrieves the value for all labels that are “in” the OKVS. In terms of security, an OKVS must encode n label-value pairs such that an adversary, even when provided with the encoding, cannot reverse-engineer the original input labels-assuming the input values are random. This means that the encoding process is oblivious to the input labels.

### Emulating RB-OKVS

Now describe how embodiments emulate RB-OKVS. To provide context, let's first recall the role of an OKVS in the OSX scheme, which will help clarify the rationale behind our emulation design. In OSX, when a client wishes to update its encrypted set held by the server, it encodes all its updates into a new OKVS and sends this OKVS to the server. Specifically, for the RB-OKVS scheme, the OKVS is represented by the encoded vector s that the client sends to the server. The server then stores this new vector alongside the previously received vectors. Later, when the server needs to check if an element exists in the client's set, it queries (i.e. decodes) all the stored OKVSs (i.e., the vectors) for that element and sends the results to F_{VODPC}.

In order to emulate, the client must convert the encoded vector s into a format that the server can store in a MongoDB database and later decode. Focusing on storage-level emulation rather than full emulation, it is sufficient to emulate the vector s into a MongoDB-compatible format.
Emulating the Encode protocol. Emulating the Encode protocol involves the client creating a document that captures both the encoded vector s and the necessary parameters for decoding. Specifically, the client generates a document with an array field called encoding, where each element corresponds to an element of the vector s. Additionally, the client includes a nested field called parameters, which stores all the values needed by the server for decoding. For instance, the document includes nested fields within parameters to convey the values of m, w, R₁ and R₂. The structure of the document for a vector s=[s₁, . . . , sₘ] is as follows:

```
{
  parameters: {
    m: <value>,
    w: <value>
    R_1: <first hash key>,
    R_2: <second hash key>
  },
  encoding: [<s₁>, <s₂>, ..., <sₘ>]
}
```

When the server receives this document, it creates a new collection called _okvs and stores the document within that collection.

```
// Here set X is a set of label value pairs
function emulateEncodeProtocol(X, m, w, R_1, R_2) {
  // Step 1: Create the encoding vector s using the Encode algorithm of RB-OKVS
  let encodedVector = RBOKVS.Encode(X, R_1, R_2);
  // Step 2: Store each element of the encoded vector in an array
  let encodingArray = [ ];
  for (let i = 0; i < encodedVector.length; i++) {
    encodingArray.push(encodedVector[i]); // Populate the array with vector elements
  }
  // Step 3: Create the parameters object
  // The parameters object will store the values needed for decoding
  let parametersObject = {
    m: m, // Store the value of m
    w: w, // Store the value of w
    R_1: R_1, // Store the first hash key
    R_2: R_2 // Store the second hash key
  };
  // Step 4: Create the document
  // This document contains the parameters and encoding array
  let encodedDocument = {
    parameters: parametersObject, // Embed the parameters object
    encoding: encoding Array // Embed the encoding array
  };
  // Step 4: Send the document to the server
  // The server stores this document in a new collection called _okvs
  sendToServer(encodedDocument);
  // Server-side pseudocode (executed upon receiving the document):
  function sendToServer(document) {
      // Create a new collection called _okvs if it doesn't exist
      if (!db._okvs) {
        db.createCollection(“_okvs”);
      }
    // Store the document in the _okvs collection
    db._okvs.insert(document);
  }
}
```

Emulating the Decode protocol. To decode a label (using the encoded vector stored in the MongoDB collection_okvs, the server would follow the pseudocode:

```
function emulatedDecode(label 1):
  // Step 1: Retrieve the document containing the encoded vector and parameters
  let doc = db._okvs.findOne( );
  // Step 2: Extract the parameters and the encoded vector
  let parameters = doc.parameters;
  let encodedVector = doc.encoding;
  // Step 3: Compute the hash values H1 and H2 for the label ‘1’
  let startingPosition = H1(parameters.R1, 1); // Computes H1(R1, 1)
  let randomBand = H2(parameters.R2, 1); // Computes H2(R2, 1)
  // Step 4: Locate the relevant subsequence in the vector ‘s'
  let subsequence = encodedVector.slice(startingPosition, startingPosition + parameters.w);
  // Step 5: Compute the dot product between the random band and the subsequence
  let decodedValue = dotProduct(randomBand, subsequence);
  // Step 6: Return the decoded value
  return decodedValue;
```

### Emulating OSX: a Set StE Scheme

In this description, the focus is on emulating OSX, building on the previous emulation of RB-OKVS.

Client initiates this

```
function emulatedInit(1^{k}):
  let K_e = SKE.keygen(1^{k})
  output K_e;
```

Client initiates this:

```
function emulatedUpdate(K_e, (X+, X−), (1^{k}, lambda, m, w)):
  let L = X+ U X−
  initialize an empty set X
  for i in |L|:
    v_i = SKE.enc(K_e, 1)
    add (1_i, v_i) to X
  let (R_1, R_2) = RBOKVS.Init(1^{k}, lambda, |L|, m, w)
  RBOKVS.emulateEncodeProtocol(X, m, w, R_1, R_2) // this adds a document in the
  _okvs collection of the server
```

Server initiates this:

```
function emulatedSQuery(Xqry):
  initialize an empty set B
  for label 1 in Xqry:
    initialize an empty set V
    for each document d in db._okvs collection:
      let v = RBOKVS.emulatedDecode(1)
      add v to V
    compute with client (\bot, b) = FVODPC(V; (K_e, 1)), where the server inputs V
and receives a bit b as output and the client inputs its key K_e, and the number 1, and receives
nothing as output
    add b to B
  output B
```

Emulating the UPSI-DD Protocol

In this section, discussed is the emulation of a full UPSI-DD protocol according to one embodiment. A focus is on emulating Step 3 of the pseudocode for repeatedPrivateMatch described above, which involves emulating the UPSI framework instantiated with OSX. For the sake of completeness, other parts of the pseudocode are included. To facilitate this process, each party maintains three collections:
1. _ upsi_last_set: This collection contains a single document that stores the set of elements present in the data collection at the time of the last intersection. It essentially captures the state of the data collection before any new updates are made.
2. _ upsi_last_intersection: This collection also contains a single document, which stores the set of elements that were part of the last computed intersection. This document is crucial for determining which elements have been retained or removed since the last intersection.
3. _ okvs: This collection comprises multiple documents, each corresponding to a distinct epoch (i.e., time between two intersections). Every document in this collection emulates an OKVS that encodes both the additions and deletions that the other party has made to their data set since the last intersection up to the current intersection.
   These collections work together to track the state and updates of each party's data, allowing for efficient and secure computation of the intersection at each epoch.
   wlog, assume Party P_X (Alice) initiates this

function repeatedPrivateMatch((1^{k}, lambda, m_1, w_1)):

| | |
|---|---|
| Alice: | // Alice initiates the UPSI-DD protocol with Bob |
| | permissionedLink.upsiEpochInitiate( ); |

Alice: // Alice computes the sets of elements she added and deleted since the last intersection

let aliceCurrentSet = db.collectionA.distinct(“fieldA”);
let aliceLastSet = db._upsi_last_set.findOne( ).elements;
let aliceAddSet = setminus(aliceCurrentSet, aliceLastSet);
let aliceDeleteSet = setminus(aliceLastSet, aliceCurrentSet);
// she sends her updates to Bob
let K_A = OSX.emulatedInit(1^{k});
OSX.emulatedUpdate(K_A, (aliceAddSet, aliceDeleteSet), (1^{k}, lambda, m_1, w_1)); //

this adds a document in the _okvs collection of Bob

| | |
|---|---|
| Bob: | // Bob computes the sets of elements he added and deleted since the last intersection |
| | let bobCurrentSet = db.collectionB.distinct(“fieldB”); |
| | let bobLastSet = db._upsi_last_set.findOne( ).elements; |
| | let bobAddSet = setminus(bobCurrentSet, bobLastSet); |
| | let bobDeleteSet = setminus(bobLastSet, bobCurrentSet); |
| | // he sends her updates to Alice |
| | let K_B = OSX.emulatedInit(1^{k}); |
| | OSX.emulatedUpdate(K_B, (bobAddSet, bobDeleteSet), (1^{k}, lambda, m_2, w_2)); // this |

adds a document in the _okvs collection of Alice
Alice (and Bob): // Alice queries all the OKVSs for the elements she added in this epoch

let aliceAddSetToIntersection_S1 = OSX.emulatedSQuery(aliceAddSet); // Note this

requires interaction with Bob
Bob (and Alice): // Bob queries all the OKVSs for the elements he added in this epoch

let bobAddSetToIntersection_S2 = OSX.emulatedSQuery(bobAddSet); // Note this

requires interaction with Alice
Alice and Bob: // using a PSU protocol, Alice and Bob compute the set of elements to be added
to the last intersection

let U = PSU(aliceAddSetToIntersection_S1; bobAddSetToIntersection_S2);
// both Alice and Bob have U after the last step

Alice: // Alice computes the intersection of her delete set with the set of elements in her last
intersection

let aliceLastIntersectionSet = db._upsi_last_intersection.findOne( ).elements;
let aliceRemoveSetFromIntersection = intersect(aliceDeleteSet, aliceLastIntersectionSet);

Bob: // Bob computes the intersection of his delete set with the set of elements in his last
intersection

let bobLastIntersectionSet = db._upsi_last_intersection.findOne( ).elements;
let bobRemoveSetFromIntersection = intersect(bobDeleteSet, bobLastIntersectionSet);

Alice and Bob: // using a PSU protocol, Alice and Bob compute the set of elements to be
removed from their last intersection

let W = PSU(aliceRemoveSetFromIntersection, bobRemoveSetFromIntersection);

Alice: // Alice updates her metadata collections

let newIntersectionSet = union(setminus(aliceLastIntersectionSet, W), U);
db._upsi_last_intersection.updateOne( { }, { $set: { elements: newIntersectionSet } };
db._upsi_last_set.updateOne( { }, { $set: { elements: aliceCurrentSet }};
return newIntersectionSet;

Bob: // Bob updates his metadata collections

let newIntersectionSet = union(setminus(bobLastIntersectionSet, W), U);
db._upsi_last_intersection.updateOne( { }, { $set: { elements: newIntersectionSet } };
db._upsi_last_set.updateOne( { }, { $set: { elements: bobCurrentSet }};
return newIntersectionSet;

Alice: // Alice retrieves her documents that have values in the intersection and sends them to Bob

let resultAlice = db.collectionA.find({ “fieldA”: { $in: newIntersectionSet } });

Bob: // Bob retrieves his documents that have values in the intersection and sends them to Alice

let resultBob = db.collectionB.find({ “fieldB”: { $in: newIntersectionSet } });

Alice and Bob: // Alice and Bob exchange their result sets
Alice: // Alice outputs the documents in the intersection

return concat(resultAlice, resultBob);

Bob: // Bob outputs the documents in the intersection

return concat(resultBob, resultAlice);

According to another aspect, database clients desire cross-customer data-sharing features for various use-cases and domains (financial services, advertising, healthcare, aviation, ML, etc.). However, concerns about data governance, privacy, and compliance with regulations make this functionality challenging for customers to implement such data-sharing features in production. There are two approaches for alleviating these concerns: (1) in industry, many Clean Room products exist for OLAP databases to enable this functionality with varying security and privacy guarantees; (2) in academia, multi-party computation (MPC) exists as a cryptographic building block to enable multiple parties to securely compute over the combination of their datasets.

To the inventors' knowledge, no existing Clean Room product easily handles OLTP workloads. As a result, customers who have OLTP workloads but want to perform data-sharing operations can only perform Clean Room operations as single-time or infrequent batch operations. From a security perspective, no existing Clean Room product has a public formal security analysis and so their security claims are unclear and generally unproven, at best. As an alternative to clean rooms, a small number of companies have deployed in-house MPC, but this is not widespread as it requires in-house cryptographers and the difficulty of designing custom MPC.

Various embodiment are configured to embed MPC directly into a distributed database ecosystem (including, for example, MongoDB) by introducing a new customer-facing process called mongop*. mongop* is a command line function that is configured to allow customers to engage in cryptographically-backed data-sharing protocols with each other without any expert knowledge in cryptography. Other process naming conventions as well as access outside of command line interfaces can be implemented in the context of other distributed database systems. In the MongoDB example, the custom-facing process is aided by a human-readable, domain-specific language called MPPL* for defining data-sharing policies, that enables seamless and easy adoption of secure data-sharing functionalities for internet scale workloads and is the first data-sharing product on the market for an OLTP database.

Various embodiments include a new cross-cluster data-sharing product for a distributed database (e.g., MongoDB) that embeds MPC functionalities directly into the existing architecture and leverages existing command/functionality protocols. This enables the seamless and easy adoption of secure data-sharing functionalities for OLTP workloads and unlike most cryptographic solutions does not increase complexity for query execution or even require understanding of the cryptographic primitives/protocols being invoked.

To provide an example, various embodiments are described with respect to MongoDB and a new customer-facing process referred to as mongop. Any database used can integrate cryptographic functionalities by adding mongop to their MonogDB deployment (or another distributed database deployment). Parties who wish to engage in a data-sharing protocol with each other can create a mongop specification, written in a custom specification language, which serves as a human-readable definition of the rules and process by which data is shared between the two parties-and the system is configured to enforce the rules, definitions, and process. For example, two parties can load the specification into their mongop instance, which is configured to act as the interface for a cryptographic protocol execution between the parties. The result of the specification is written back into each customer's cluster as normal documents and can be retrieved using a normal MongoDB driver. The specification language is designed to be human-readable and requires no understanding of cryptography, allowing non-security-experts to utilize the technology and audit data-sharing policies.

In various embodiments, data-sharing for OLTP workloads enable new applications that only exist when data-sharing takes place on a more frequent basis (e.g. minutes/hourly/daily) and for applications where data governance policies prevent duplication of data to an OLAP database, improving these secure data-sharing instantiation over conventional approaches. For example:
Financial Services: Fraud detection via data-linkage can occur more frequently and at the OLTP database level without having to copy data over to an OLAP database, reducing the potential risk of data loss.
Advertising: Advertisers can conduct targeted advertising at the point of purchase as opposed to sending campaigns days after an impression.
Aviation: Airlines are prohibited from sharing specifics on airfare (due to price fixing regulations) even if they are alliance partners, but still need to share itinerary data with partner airlines in a compliant manner to perform settlement of loyalty mile programs within the alliance. This settlement normally takes place on a monthly cadence, but by moving data-sharing functionalities to the OLTP database, they can perform settlement on a more frequent cadence (daily, hourly).

The new customer-facing process can be referred to as mongop. According to one embodiment, mongop acts as an interface for other mongop instances to engage in a data-sharing protocol with the customer's cluster. Customers who wish to engage in a data-sharing protocol with another customer run mongop persistently on a node in their cluster and then configure each of their mongop instances by using the mongop specification language, which determines the rules and operations that are performed for a given data-sharing process. The mongop instance is configured to compile the specification into the necessary cryptographic protocol building blocks automatically without any need for the customer to understand the underlying cryptography.

Shown in FIG. 2 is an example of the mongop implementation (e.g., 202 220) where each is composed of three main components:
The Specification Engine (e.g., 204, 222), which parses mongop specifications written in the mongop specification language and is configured to determine which data to retrieve from the customer's cluster.
The Crypto Engine (e.g., 206, 224), which compiles a specification into the necessary cryptographic building-blocks and is configured to perform a “protocol planning” process to optimize the number of round-trips/bandwidth required between mongop instances.
The Networking Engine (e.g., 208, 226), which implements the networking between mongop instances.
Driver (210, 228): control access to functionality, and manage defined/permitted access between mongop instances (202, 220) via a communication link (e.g., 212) and communication with respective core servers (e.g., 230 and paired core server (not shown) via a communication link (e.g., 222).

According to some embodiments, the result obtained from execution of the specification are written back into each user's cluster (e.g., 230) as normal documents and can be retrieved using a normal MongoDB driver (e.g., mongod) and known MongoDB architecture (e.g., mongos, mongod, primary nodes, secondary nodes, etc.). For any MongoDB implementation, the core server 230 can provide database server to an application 240 and its associated driver 242, which can now leverage fully secret shared data via normal drivers/architecture due to integrating mongop functionality. According to one embodiment, the driver (e.g., is where the cryptographic keys are stored, and the server is where the data is stored

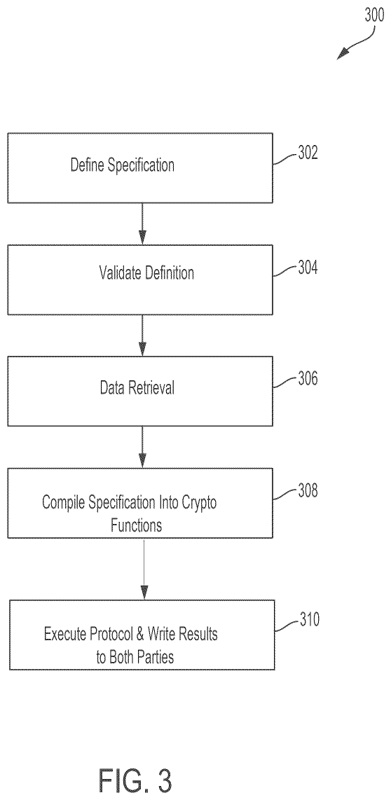

Various embodiments include any of the replica set architecture/functionality, query execution, stages, as well as shard-based architectures/functionalities described herein, including descriptions incorporated by references herein. An example process flow of a high-level outline of a mongop protocol execution (from loading a specification, transforming it into cryptographic operations, and executing the protocol) is shown in FIG. 3.

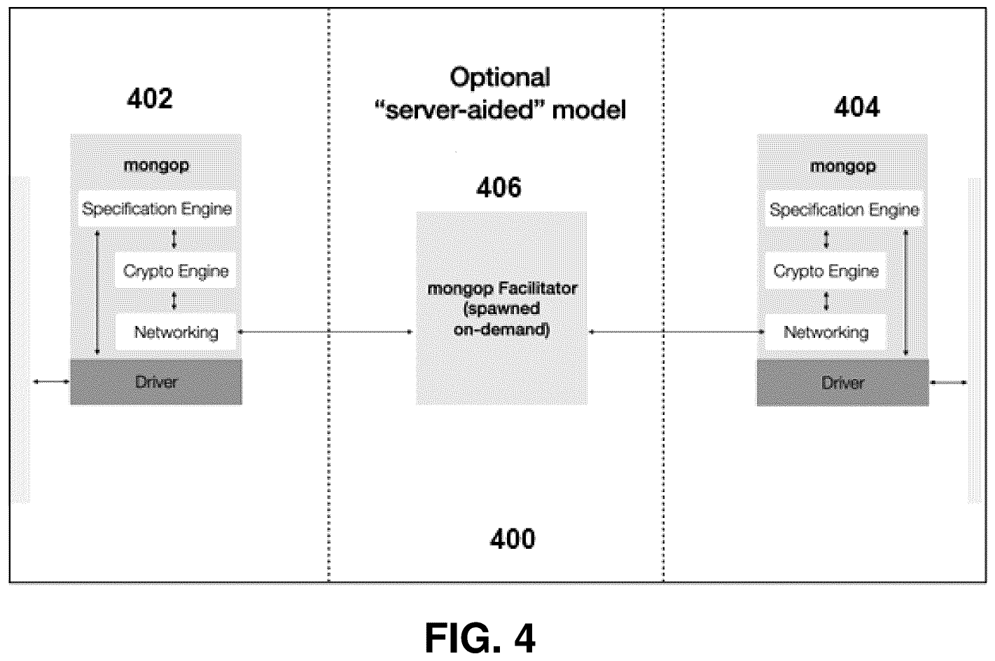

According to some embodiments, the architecture described includes functionality where the parties that participate in a mongop data-sharing protocol are willing to accept incoming requests from the other party. Additional security-sensitive measures can be implemented to avoid exposure to the mongop part of their network even to a trusted counterparty. FIG. 4 shows an additional example architecture which avoids this exposure. In some embodiments, this improved security architecture is referred to as a “server-aided” model (discussed in greater detail below).

According to some embodiments, database users interact with mongop through a domain-specific language called MPPL (MongoP Policy Language)-other designations can be used with other database instances and their respective query languages. For example, MPPL is designed to be human-readable and easy-to-use so that parties can define and agree on cryptographic protocols without any knowledge of cryptography.

According to one embodiment, the specification language can include a variety of choices of syntax, and in some examples syntax choice is relatively arbitrary. Changes to the example syntax can be tailored to specific distributed database implementations. In some examples, the syntax can be configured to be visually distinct from the underlying database query language (e.g., MQL).

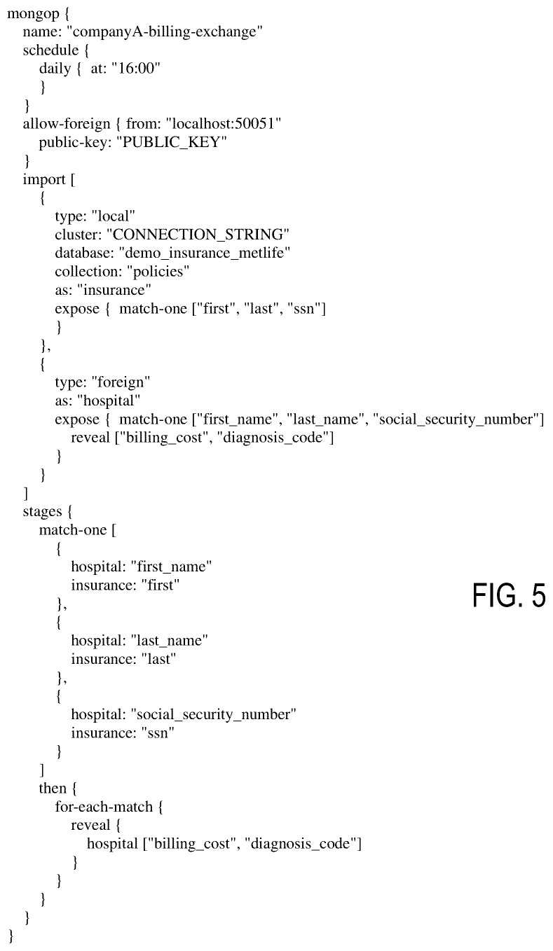

The code shown in FIG. 5 provides an example specification between a health insurance company and a hospital, written from the perspective of the insurance company. The specification imports the insurance company's data into the pipeline and expects that the hospital imports its own data. The system executes a match-one operator to perform a one-to-one join between records that share the same first name, last name, and social security number in both the insurance and hospital company's dataset. Finally, the system uses the reveal operator to send various columns from the hospital to the insurance company.

According to some embodiments, the MPPL specification includes at least one or more or any combination of the following attributes: name, allow-foreign, import, and stages where:
The name attribute defines an identifier for the given MPPL specification. It is used by foreign mongop instances to initiate a protocol and is also used in logging.
The (optional) schedule attribute defines how frequently the MPPL specification should be run.
The allow-foreign attribute defines the access control requirements that any foreign mongop instance must satisfy to engage in this particular protocol.
The import attribute defines and assigns identifiers to the datasets that will be used in the protocol. Imports can either be local (meaning they will be imported by the local mongop instance) or foreign (meaning they are expected to be imported by a third-party). In this example, the execution imports a local dataset and assigns it the insurance identifier and imports a foreign dataset with the hospital identifier.
The stages attribute defines the data-sharing pipeline that both parties engage in.

When this specification is run, the documents in the insurance dataset that match with a document from the hospital dataset will be updated with a billing_cost and diagnosis_code field with values that correspond to the matching document from the hospital dataset.

From the database user perspective, the process of using mongop is the following:
1. Find another user to engage in a data-sharing pipeline.
2. The users separately install and run mongop as a persistent process. (It is not required for mongop to be physically in the same node/region as the user's cluster, but doing so can help performance.) The database users confirm that the mongop process has the appropriate firewall/network configuration settings to accept outside network traffic.
   a. Includes generation of a public-key for use in MPPL specifications.
3. Both users agree on a set of MPPL stages and exchange public-keys.
4. Each user adds a new MPPL specification to their mongop instance's configuration file. The specification if valid has the same stages as agreed on in the previous step. The user fills in any remaining attributes as desired.
5. If a schedule is defined, the MPPL specification is run automatically by the mongop instance. If the schedule was not defined, a user can initiate a manual run of the MPPL specification using mongop command-line flags.
6. Assuming all of the necessary access control checks pass and the MPPL specification is the same on both sides, the mongop instances run the MPPL specification and data is written back into the respective users' collections as specified.
7. The users can periodically retrieve the result of the MPPL specification by querying their MongoDB cluster with a normal MongoDB driver.

According to some embodiments, the architecture enables two database users to perform a “private join”/“private match” between their datasets and share data for records that match. This capability is easy to use without even requisite knowledge of the cryptographic operations being used. Various distributed databases can be augmented using the implementation of private function nodes in existing architectures. Various existing query languages can be augmented, for example, as described with respect to the MongoDB implementation. The architecture can be used to immediately realize several new data-sharing workloads. The following examples illustrate improvements over conventional approaches:
Faster data-exchange protocols: The server-aider PSI technique enables PSI to be run on sets that are very, very large as long as the two parties agree on a semi-honest, third-party server. In one example, this technique can be implemented by spawning a server on demand (e.g., using Atlas infrastructure) when MPPL specifications are run (discussed in greater detail below, FIG. 4).
Faster “updatable PSI” protocol: some instances require the protocol to be run over each party's entire dataset on each execution. Further examples implementing “updatable PSI” techniques allow parties to only have to perform computations on the deltas between each protocol execution.
Other types of aggregations: current examples support basic data-linking, but additional implementation can also use techniques including homomorphic encryption to support mathematical operations like sums and (to a limited extent) multiplications. This integration enables more expressive aggregations in the MPPL language in private contexts.

### Example Considerations: Risks

The mongop architecture is configured to expose the mongop node to the outside internet to accept connections. Each customer accepts incoming connections from other customers. The disclosed architecture limits this risk in only exposing the mongop server to outside connection.
   Example Mitigation: Eliminate the requirement for mongop to accept incoming connections by using the “server-aided” approach mentioned in FIG. 4. The “server-aided” approach solves the networking issue and provides additional efficiency reasons to use the “server-aided” approach.
Customers may have difficulty understanding the security benefits of the approach in comparison to existing Clean Room products.
   Example Mitigation: communication of the security benefits can be achieved through notification of (1) established expertise in MPC and PSI, (2) developer education via documentation, and (3) developer education via direct customer interactions with Product and Field Engineers.
It is noted that introducing a new cryptographic product grounded in academic formalism may “invite” researchers to try to write attacks about such implementation.
   Example Mitigation: Require publishing of paper and analysis upfront as a blocker for the first public-facing release.

FIG. 3 shows an example process 300. Process 300 includes a mongop protocol execution. An example mongop protocol can occur according to the following steps:
1. Both customers (with a mongop already set up) agree on a mongop specification out-of-band.
2. Each party loads the specification into mongop, which parses it and performs sanity checks.
3. Once mongop loads the specification, it waits in a “ready” state where it listens for a protocol “init” message from another mongop instance.
4. One of the mongop instances sends an “init” message to the other mongop. This is triggered manually by the customer or automatically by mongop following a “schedule” in the mongop Specification. (e.g., any one or more or combination of steps 1-4 can be executed as or part of 302).
5. Both mongop instances perform a “handshake” to establish the connection. They check that both parties are authorized to engage in a protocol for the desired mongop Specification (access control) and verify that they agree on the same Specification. (e.g., at 304).
6. The Specification Engine on both mongop instances retrieves the necessary data from the cluster. (e.g., 306).
7. The Crypto Engine on both mongop instances compiles the specification into the necessary cryptographic building-blocks. (e.g., 308). An example of a PSI protocol used to support the match-one operation is described in greater detail below (e.g., “OPRF PSI”).
8. Both mongop instances use the networking interface to engage in the protocol as compiled in the Crypto Engine.
9. On conclusion of the protocol, the mongop instance writes the result data back to each customer's database as specified in the mongop Specification. (e.g., any one or more or combination of steps 8-9 can be executed as or part of 310).

FIG. 4 is a block diagram of an example server-aided model 400. The server aided implementation is an optional extension of the mongop architecture where the mongop nodes (e.g., 402, 404) communicate with a third-party facilitator node (e.g., 406) in lieu of direct communication. According to various examples, the facilitator node can be spawned on-demand (e.g. via Atlas infrastructure or other node creation functions associated with other distributed database implementations) for the duration of the protocol execution.

Various embodiments implement the facilitator node, which can come with increased mongop implementation complexity, but with a number of benefits:
Users no longer have to allow their mongop instances to accept incoming requests from other users.
Improved performance with server-aided protocols.
The server-aided model makes it easier to support more than two parties that participate in a data-sharing protocol (not just two).

### Example PSI Protocol: OPRF PSI

In various examples, the system can implement a PSI protocol based on Oblivious Pseudorandom Functions (OPRFs). A OPRF is like a pseudo-random function (PRF) where one party (the receiver) knows the input to the function and learns the output of the function but does not learn the secret key and the other party (the sender) knows the secret key but does not learn the receiver's input to the function or the output from the function. According to one embodiment, the PSI protocol works as follows:
1. The sender initializes an OPRF and samples a random OPRF secret key.
2. The sender computes the OPRF over all the elements of their set and sends the OPRF tags to the receiver.
3. The receiver computes the OPRF over all the elements of their set.
4. The receiver performs set intersection over their OPRF tags and the sender's OPRF tags. The tags in the intersection correspond to the elements that were in both party's sets.
5. The receiver tells the sender the intersection.

### Example Embodiments and Implementation

According to one embodiment, encrypted search can be implemented in an end-to-end encryption setting. For example, modern crypto implementation invokes encrypted search algorithms which allow a data owner to encrypt their data while still leveraging search and database operations hosted by a database provider.

According to another embodiment, a database management system can be configured to support private set intersection. For example, private set intersection (PSI) allows two or more parties with sensitive datasets to find out which elements of their data are in common without sharing their data with each other. In various embodiments, PSI enables very powerful technologies. OSX and ESX provide details for protocols for dynamic updatable PSI. Further embodiments, provide database operators, including command line operators, that can be used as part of query execution, updates, deletes, aggregation, etc., for example, that are mapped to the protocols and functions disclosed in with respect to PSI, OSX, ESX, MPC, etc. Database clients may invoke the database operators for execution by the database system, enabling execution of the underlying protocols without needing the client to understand the specifics of cryptographic operations the operators are executing.

Any database client/user can leverage these private/cryptographic operators to take advantage of secure and privacy preserving operations. For example, PSI could be used by hospitals, and even, across states to find patients they have in common without violating HIPAA—because the data is still private. Further, PSI can be leveraged by bank clients/users to find out if any of their customers are on a secret/private sanctioned list.

In further embodiments, the system can be configured to provide secure multi-party computation, which can be accessed, for example, as a database operator in a query interface (e.g., visual, command line, etc.). As in other database implementations (e.g., well known MongoDB, U.S. Pat. No. 10,621,200, incorporated by reference herein, having known query operators (e.g., MQL, SQL, etc.), the addition of privacy preserving operators provide significant advantages. For example, secure multi-party computation (MPC) can be provided via a database operator, which allows two (or more) parties with private datasets to execute an algorithm on the union of their data without sharing their data with each other. (e.g., detailed herein are some example operations that can be invoked by database operators and includes example encryption schemes and/or protocols to which operators can be mapped). The algorithm executed using MPC could be, for example, a supervised machine learning algorithm in which case it would result in a technology that would enable company A with a highly valuable and mission critical ML algorithms to train a model on company B's large and very sensitive training data without A learning anything about B's data (beyond what the model itself reveals) and without B learning anything about A's algorithm and (resulting) model.

Additionally, when MPC is executed for a statistical/analytical algorithm then the result is a technology that enables an analyst A to study a sensitive dataset owned by an entity B without A learning anything about B's data (beyond the result of the analysis) and without B learning anything about A's results.

According to another embodiment, the system can be configured to execute database operators that provide differential privacy. For example, the system can enable differential privacy which allows a data owner to answer the queries of an analyst without revealing “too much” information about any individual record in the data set. A very high level (and not necessarily technically accurate) way to think about this is described to facilitate understanding. For example, differential privacy allows the analyst to learn statistical information (e.g., average, mean, percentiles) about the data set without revealing information about any of the individuals in the data set beyond what can be inferred from the statistical information.

Various embodiments of the database enable users to define private data sets, determine what data is contributed to those data sets and what resulting information can be obtained. For example, the system can enable and execute queries on private data sets and be configured to return aggregate information from combined private data sets. In another example, multiple database users can each define their own private data and set permissions on which private queries/updates can be executed on the combination of the private data sets. The system enables configuration between users who register to share data sources and enables definition of the scope of the sharing of the data.

In some embodiments, MongoDB implementation can include database operators linked to modern cryptographic protocols to provide advanced cryptographic functions. For example, command line operators can be provided, and callable during ordinary queries or updates. As MongoDB is a well-known enterprise solution, augmenting pre-existing implementation (existing command line operators) with modern cryptographic operators provides an easy and cost effective way for database customers to use and benefit and learn of these highly sophisticated and cutting edge crypto technologies, ultimately improving the security and efficiency of the database implementation.

To highlight example technical improvements this provides, suppose a bank or a hospital wanted to leverage encrypted search or secure multi-party computation for their applications. Conventionally, they would have to hire 4-5 crypto experts (e.g., holders of cryptography PhDs) who specialize in these subfields to design a solution and then would need a team of crypto engineers to build it. How would they find these experts? Why would these experts, most of whom are in academia or industry research labs, even want to work for a bank or healthcare provider? Ultimately, without integrated database operators that provide this modern cryptographic functionality, it is just not feasible for any but a few large tech companies to build and make use of these technologies, and the approach that such large companies conventionally use is to develop bespoke solutions tied to their own architectures.

Various aspects provide implementation to enable conventional database architectures (e.g., relational, dynamic schema, etc.) to collaborate securely and privately on behalf of users. According to various embodiments, a database management system and/or service is configured to provide a secure and multi-party database platform. The platform is customizable to not only store and process customer A's data but also has the ability to securely process (i.e., analyze, match etc.) customer A and B's (and even A+B+C, A+C+D, etc.) data together. Each party can accept or define another party to share private data. Once the designated parties, private data sources, and access levels are defined (e.g., via registration) the system executes private queries, provides private set intersection, secure multi-party computation, differential privacy, etc.

According to one embodiment, the platform hosts a database where customer A and B can execute any one or more of the following operations. Initially, A and B “link” their databases together by executing a link or permission function:

$$\begin{matrix}Customer A : linked AB = db . collectionA . link ( uriStringB ) ; \\ Customer B : linked BA = db . collectionB . link ( uriStringA ) ;\end{matrix}$$

Once the databases are linked, A (resp. B) can write applications using the following operations:
linkedAB.privateMatch(“field1”, “field2”, . . . ): returns the documents in A and B's databases that have the same values for field1 and field2 etc. with the cryptographic guarantee that A will not learn any information about the non-matching documents in B's database and B will not learn any information about the non-matching documents in A's database.
linkedAB.privateJoin(“fieldA”, “fieldB”): to each document in A's database, the privateJoin operation adds a new array field whose elements are the matching documents from B's database. This operation provides the cryptographic guarantee that A will not learn any information about the non-matching documents in B's database and B will not learn any information about A's database.
   A and B are able to access private aggregation pipeline functionality. The private aggregation pipeline can include the following operators which are applied to returned results (e.g., of a privateMatch operation):
$privateCount: returns the number of matching documents with the cryptographic guarantee that A learns nothing about B's database and B learns nothing about A's database;
$privateMedian: returns the median with the cryptographic guarantee that A learns nothing about B's database and B learns nothing about A's database;
$privateSum: returns the sum with the cryptographic guarantee that A learns nothing about B's database and B learns nothing about A's database;

In various embodiments, varying levels of privacy can be implemented (e.g., by only allowing private aggregation operations or permitting private queries, etc.) such that if a private aggregation operation is applied to a privateMatch query then A and/or B would learn only the final result of the pipeline and none of the intermediary results, including the results of the privateMatch query. Various embodiments are configured to strengthen this security by adding differential privacy.

According to other aspects, the private data functions provided by the platform can enable any arbitrary application to have access to and leverage hosts of data that a counterparty wishes to remain private. Some examples of applications that could be built with a secure multi-party database are provided to illustrate. To highlight options for functionality most examples focus on scenarios where A and B are different entities but note that A and B could be different organizations in the same company, or A could be a Realm database and B could be an Atlas database, and other parties with data in different formats can also access the database platform register their data (e.g., including transformation of a plain text database source into a private version). A could hold dynamic schema data and B relational data, among other options.

### Secure Matching Example

Consider two healthcare providers each with their own patient databases. Now suppose provider A would like to know if a patient was also treated by provider B but is not allowed to release patient information to provider B and vice versa. A multi-party database would allow provider A to learn whether the patient is also being treated by provider B without A learning any information about B's other patients and without B learning any information about A's patients (see e.g., $private . . . operators above). More generally, the providers could find all the patients they have in common. Note that private matching could be useful in a wide variety of industries beyond healthcare, including advertising, finance and government.

### Secure Multi-Party Analytics Examples

Suppose that retailer A has a large database of all its purchases over the last twenty years. This data is valuable to A because it can be used to gain insight into its operations but also needs to be protected from competitors. Retailer A, however, may want to use some of its data together with data from its partners to optimize its supply chain. With a secure multi-party database, Retailer A and its partners could build a supply chain analytics application that would provide them with insights without any of them learning anything about each other's data (as discussed above). Similar multi-party applications could be built for healthcare analytics, e.g., allowing an insurance company or a payment processor to detect trends in patient healthcare or even fraud.

### Secure Multi-Party ML Example

Consider a large social network A that has very personal and sensitive information about its users. Now suppose a different organization in the same company would like to use that data to build a machine learning model to detect fraud and abuse but is not allowed to access that data due to either regulation or to negative public perception. With a secure multi-party database, the machine learning model could be built from the sensitive data without the training algorithm ever accessing the training data in plaintext.

### Network Effect Examples

Social networks and messaging apps benefit from network effects which are achieved when the value or utility a user derives from a good or service depends on the number of users of compatible products” Embodiments of the secure multi-party database could also benefit from these network effects (without the need to share the collective data). Suppose, for example, that a large and influential healthcare provider adopted such a database platform. It would stand to reason that most of its partners (e.g., insurance companies, payment processors etc.) might adopt the same database platform since doing so would provide the opportunity to perform private analytics on the healthcare provider's data. Similar scenarios are available to all large and influential players in various markets (e.g., retailers like Walmart or large and influential government agencies like the National Health Service of the U.K).

Various embodiments of the platform are configured to enable selection of advanced crypto features to include or implement in a database architecture. In currently available MongoDB implementation, users can make selections from a plurality of storage engines that each provide different performance profiles. In various embodiments, the ability to select and design an architecture to specific performance and security goals and private functions is an improvement over current approaches, and enables selection/architecture design based on a plurality of crypto engines each having their own security properties and/or private functionality.

### Database-level integrity Example

Various embodiments leverage the above crypto functionality to provide verification of dynamic schema database instances the integrity of its database; that is, to check if the database was tampered with in any way. Imagine a bank whose database stores balances. The ability for someone to modify a balance or exchange existing balances from one user to another without detection could have disastrous consequences.

### Encrypted Atlas Search Enhancement Examples

Atlas search in the known MongoDB database allows developers to build full-text search indexes over their Atlas databases. If this data is sensitive or mission critical, the system can be improved to guarantee that their collection and search indexes are secured. For example, using encrypted search, the platform enables an end-to-end encrypted version of Atlas search that would work as follows. First, an application would encrypt its collection and build an encrypted search index; all with its own keys. It would then send the encrypted collection and the encrypted search index to Atlas. From this point on, the application could send encrypted search queries to Atlas which Atlas would use to query the encrypted search index (without the ability to decrypt it) and return the matching encrypted documents to the application.

### Sharding and Field Level Encryption (FLE) Enhancement Examples

Sharding affects the security of encryption functions (e.g., FLE) in subtle ways. One issue is that sharding on FLE encrypted fields can leak information depending on the sharding strategy that is used. For example, range sharding on an FLE encrypted field reveals (approximate) frequency information about the field even in the weakest possible adversarial model. Hashed sharding may leak less but improving security by integrating cryptographic operations discussed above would provide advantages over both architectures.

Commonly owned patent publication US 2017-0091327, entitled “DISTRIBUTED DATABASE SYSTEMS AND METHODS WITH PLUGGABLE STORAGE ENGINES,” described aspects of selectable storage engines that can be improved by integrating selectable cryptographic engines each tailored to provide aspects of the functionality described above. Further, execution of the private operations can be performed as part of a cryptographic stage of execution. In some examples, the cryptographic stages can be integrated with other stages of execution (e.g., like those described in US 2017-0262517A1, US 2018-0004804A1, US 2017-0262516 A1, incorporated by reference herein). In some embodiments, dependency analysis can be performed to determine execution ordering of stages and/or operations within a database request.

### NUMBERED EMBODIMENTS

1. A distributed database system comprising: at least one processor, operatively connected to a memory, the at least one processor configured to: manage operations of a distributed database system; enable cryptographic operations on private versions of database data sources across multiple data controllers; map private data operators to cryptographic protocols configured to execute: arbitrary updates and deletes on private data of the multiple data controllers; and encrypted match operations on the private data of the multiple data controllers under a cryptographic guarantee that a querying party will not learn any information about non-matching documents in another party's private data, and the cryptographic guarantee that the another party will not learn any information about the non-matching documents in a querying party's private data.
2. A system for integrating private operations over private data sets in a distributed database, the system comprising: at least one processor, operatively connected to a memory, the at least one processor configured to: execute private data operators mapped to a dynamic structured encryption scheme for updating encrypted sets held at least by a first party and a second party; and a first private data operator configured to perform an encrypted match operation to determine an intersection of private data held by the first party and the second party, wherein execution of the encrypted match operation limits return of any results to query equality (e.g., returns documents in A and B's databases that have a same values for searched field (e.g., field1 and field2 etc.)) and provides a cryptographic guarantee that querying party will not learn any information about non-matching documents in the second party's private data, and the cryptographic guarantee that the second party will not learn any information about the non-matching documents in the first party's private data.
3. The system of any preceding embodiment, wherein the at least one processor is configured to execute a two party private computation on the private data in response to executing at least one of the encrypted match operations or at least one of the arbitrary updates or deletes operations and return results from the at least one of the encrypted match operations or at least one of the arbitrary updates or deletes operations to both parties participating in the two party private computation.
4. The system of any preceding embodiment, wherein the at least one processor is configured to execute at least one private data operator that is mapped to a secure multi-party computation operation on the private data held by the querying party and the another party.
5. The system of any preceding embodiment, wherein the at least one processor is configured to enable designation of private data sources, and designation of at least a first and second party that can execute private data operators against the private data sources.
6. The system of any preceding embodiment, wherein the at least one processor is configured to accept registration information and configuration settings for defining differential privacy level or access to the private data.
7. The system of any preceding embodiment, wherein the at least one processor is configured to enable the at least first party and second party to define a specification governing exchange of information within the private data sources.
8. The system of any preceding embodiment, wherein the at least one processor is configured to validate contributions to the specification by the at least first party and second party.
9. The system of any preceding embodiment, wherein the at least one processor is configured to host a separate data node storing the private data for respective parties.
10. The system of any preceding embodiment, wherein the at least one processor is configured to manage execution of the private data operators to only access respective data nodes storing the private data for the respective parties.
11. The system of any preceding embodiment, wherein the at least one processor is configured to host a communication node configured to manage execution of the private data operators to access respective data nodes storing the private data for the respective parties through the communication node, and communicating results from the private data operators to the respective parties through the communication node.
12. A computer implemented method for executing any of the preceding system embodiments.
13. A computer readable medium storing instructions that when executed cause at least one processor to execute a method of any of the preceding embodiments.

FIG. 1 is a block diagram of an example computer system that is improved by implementing the functions, operations, and/or architectures described herein. Modifications and variations of the discussed embodiments will be apparent to those of ordinary skill in the art and all such modifications and variations are included within the scope of the appended claims. Additionally, an illustrative implementation of a computer system 1300 that may be used in connection with any of the embodiments of the disclosure provided herein. The computer system 1300 may include one or more processors 1310 and one or more articles of manufacture that comprise non-transitory computer-readable storage media (e.g., memory 1320 and one or more non-volatile storage media 1330). The processor 1310 may control writing data to and reading data from the memory 1320 and the non-volatile storage device 1330 in any suitable manner. To perform any of the functionality described herein (e.g., private set creation, interaction, management, updating, etc.), the one or more processor 1310 may execute one or more processor-executable instructions stored in one or more non-transitory computer-readable storage media (e.g., the memory 1320), which may serve as non-transitory computer-readable storage media storing processor-executable instructions for execution by the one or more processors 1310.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described herein) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

In other embodiments, various ones of the functions and/or portions of the flows discussed herein can be executed in different order. In still other embodiments, various one of the functions and/or portions of the flow can be omitted, or consolidated. In yet other embodiments, various one of the functions and/or portions of the flow can be combined, and used in various combinations of the disclosed flows, portions of flows, and/or individual functions. In various examples, various one of the screens, functions and/or algorithms can be combined, and can be used in various combinations of the disclosed functions.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A distributed database system comprising:
at least one processor, operatively connected to a memory, the at least one processor configured to:
manage operations of a distributed database system;
enable cryptographic operations on private versions of database data sources across multiple data controllers;
map private data operators to cryptographic protocols configured to execute:
arbitrary updates and deletes on private data of the multiple data controllers; and
encrypted match operations on the private data of the multiple data controllers under a cryptographic guarantee that a querying party will not learn any information about non-matching documents in another party's private data, and the cryptographic guarantee that the another party will not learn any information about the non-matching documents in a querying party's private data.

2. The system of claim 1, wherein the at least one processor is configured to execute a two party private computation on the private data in response to executing at least one of the encrypted match operations or at least one of the arbitrary updates or deletes operations and return results from the at least one of the encrypted match operations or at least one of the arbitrary updates or deletes operations to both parties participating in the two party private computation.

3. The system of claim 1, wherein the at least one processor is configured to execute at least one private data operator that is mapped to a secure multi-party computation operation on the private data held by the querying party and the another party.

4. The system of claim 1, wherein the at least one processor is configured to enable designation of private data sources, and designation of at least a first and second party that can execute private data operators against the private data sources.

5. The system of claim 4, wherein the at least one processor is configured to accept registration information and configuration settings for defining differential privacy level or access to the private data.

6. The system of claim 4, wherein the at least one processor is configured to enable the at least first party and second party to define a specification governing exchange of information within the private data sources.

7. The system of claim 6, wherein the at least one processor is configured to validate contributions to the specification by the at least first party and second party.

8. The system of claim 1, wherein the at least one processor is configured to host a separate data node storing the private data for respective parties.

9. The system of claim 8, wherein the at least one processor is configured to manage execution of the private data operators to access respective data nodes storing the private data for the respective parties.

10. The system of claim 8, wherein the at least one processor is configured to host a communication node configured to manage execution of the private data operators to access respective data nodes storing the private data for the respective parties through the communication node, and communicating results from the private data operators to the respective parties through the communication node.

11. A computer implemented method for managing a distributed database system comprising:
managing, by at least one processor operations of a distributed database system;
enabling, by the at least one processor, cryptographic operations on private versions of database data sources across multiple data controllers;
wherein the enabling includes mapping, by the at least one processor, private data operators to cryptographic protocols;
executing, by the at least one processor, arbitrary updates and deletes on private data of the multiple data controllers; and
executing, by the at least one processor, encrypted match operations on the private data of the multiple data controllers under a cryptographic guarantee that a querying party will not learn any information about non-matching documents in another party's private data, and the cryptographic guarantee that the another party will not learn any information about the non-matching documents in a querying party's private data.

12. The method of claim 11, wherein the method comprises:
executing a two party private computation on the private data in response to executing at least one of the encrypted match operations or at least one of the arbitrary updates or deletes operations; and
returning results from the at least one of the encrypted match operations or at least one of the arbitrary updates or deletes operations to both parties participating in the two party private computation.

13. The method of claim 11, wherein the method comprises executing at least one private data operator that is mapped to a secure multi-party computation operation on the private data held by the querying party and the another party.

14. The method of claim 11, wherein the method comprises enabling designation of private data sources, and designation of at least a first and second party that can execute private data operators against the private data sources.

15. The method of claim 14, wherein the method comprises accepting registration information and configuration settings for defining differential privacy level or access to the private data.

16. The method of claim 14, wherein the method comprises enabling the at least first party and second party to define a specification governing exchange of information within the private data sources.

17. The method of claim 16, wherein the method comprises validating contributions to the specification by the at least first party and second party.

18. The method of claim 11, wherein the method comprises hosting a separate data node for the respective parties storing respective private data.

19. The method of claim 18, wherein the method comprises managing execution of the private data operators to access respective data nodes storing the private data for the respective parties.

20. The method of claim 18, wherein the method comprises hosting a communication node configured to manage execution of the private data operators to access the separate data nodes storing the private data for the respective parties through the communication node, and communicating results from the private data operators to the respective parties from the communication node.
